(19) United States
(12) Patent Application Publication
(10) Pub. No.: US 2013/0014832 A1
(43) Pub. Date: Jan. 17, 2013

(54) HEATER STRUCTURE

(71) Applicants: Kazutaka IDA, Hamamatsu-shi (JP); Hironori WATANABE, Hamamatsu-shi (JP); Muneaki IKUMA, Hamamatsu-shi (JP); Satoshi KAWAI, Chiryu-shi (JP); Yoshihide OGAWA, Anjo-shi (JP)

(72) Inventors: Kazutaka IDA, Hamamatsu-shi (JP); Hironori WATANABE, Hamamatsu-shi (JP); Muneaki IKUMA, Hamamatsu-shi (JP); Satoshi KAWAI, Chiryu-shi (JP); Yoshihide OGAWA, Anjo-shi (JP)

(73) Assignees: TOYOTA JIDOSHA KABUSHIKI KAISHA, Toyota-shi (JP); KURABE INDUSTRIAL CO., LTD., Hamamatsu-shi (JP)

(21) Appl. No.: 13/531,586

(22) Filed: Jun. 25, 2012

(30) Foreign Application Priority Data
Jul. 11, 2011 (JP) 2011-153100

(51) Int. Cl. F16K 49/00

(52) U.S. Cl. 137/334

(57) ABSTRACT

The present invention discloses a heater structure that is composed of a heat generator and a mold. The heat generator is comprised of a PTC heating element having a pair of electrode layers, a first electrode terminal, a second electrode terminal, an insulation case that is a box shape with one side opened. An opening surface of the insulation case faces with the air pump, a protective sheet is placed, and a sum of a thickness of the mold with which the air pump is in contact and a thickness of the protective sheet is thinner than a thickness on an opposite side of the mold in the heater.

### CROSS-REFERENCES TO RELATED APPLICATIONS

The present application is related to the Japanese Patent Application No. 2011-153100, filed Jul. 11, 2011, the entire disclosure of which is expressly incorporated by reference herein.

### BACKGROUND OF THE INVENTION

1. Field of the Invention

The present invention is related to a heater structure that is available for a secondary air supplying device or other devices of an internal combustion, especially available for an air pump efficiently.

2. Description of the Related Art

Conventionally, it is known that a secondary air supplying device that can reduce emissions of toxic substances by supplying a secondary air to a catalyst mounted on an exhaust system of an internal combustion for cleaning exhaust gas to ensure immediate activation of the catalyst.

Documents 1 to 10 are shown below.

Document 1: Japanese Patent Application Publication No. H06-241034

Document 2: Japanese Patent Application Publication No. 2009-052496

Document 3: Japanese Patent Application Publication No. 2009-138529

Document 4: Japanese Patent Application Publication No. 2010-135274

Document 5: Japanese Patent Application Publication No. S60-049604

Document 6: Japanese Examined Patent Application Publication No. H01-021601

Document 7: Japanese Utility Model Publication No. S56-051288

Document 8: Japanese Utility Model Publication No. S62-103203

Document 9: Japanese Patent Application Publication No. H08-306469

Document 10: Japanese Patent Registration No. 3804695

For example, the documents 1 to 3 disclose a technology to ensure immediate activation of the catalyst by heating the secondary air.

On the other hand, about antifreezing for various devices, it is publicly known that devices are heated by a heater equipped with various heating elements to prevent devices from freezing. Especially, a positive temperature coefficient thermistor (hereafter abbreviated as PTC) heating element is focused and used in various categories. This is because the PTC heating element has a specific resistance value at low temperature to function as a heating element and rapidly increases the resistance value and cuts off the flow of electricity at a predetermined temperature (Curie temperature) or higher to control its own temperature and maintain extremely high safety. A PTC heat generator suitable for an antifreezing heater for various devices can be acquired by connecting a pair of electrode terminals to the PTC heating element having the above described features and insulating them properly.

Concerning the PTC heat generator described above, the document 4 discloses a PTC heater that is comprised of a PTC heating element having a pair of electrode layers, a first electrode terminal, a second electrode terminal, and an insulation case, wherein the first electrode terminal and the PTC heating element are electrically connected and installed in the insulation case, and the second electrode terminal is made of an elastic metal plate and has a substantially U-shaped cross section. By using a U-shaped opening to hold the PTC heating element, the first electrode terminal and the insulation case the second electrode terminal and the PTC heating element are electrically connected, and the second electrode terminal and the first electrode terminal are insulated by the insulation case. In addition, the documents 5 to 10 are related to the PTC heating element.

In the technologies concerning a vehicle equipped with the secondary air supplying device disclosed in the documents 1 to 3, there is not enough consideration about reduction in temperature caused by wind when the vehicle runs at high speed.

### BRIEF SUMMARY OF THE INVENTION

Although the heater described in the document 4 has high heating efficiency, but the heater cannot transfer heat to a heating object efficiently in order to use the heating devise as a heat source. Especially, when the PTC heating element is used as a heat generator, the PTC heating element generates heat without exceeding the Curie temperature because the resistance value of the element increases at the Curie temperature. Therefore, unless the heat is transferred effectively, the PTC heating element is kept around the Curie temperature and the heating object is not heated at all. On the other hand, a mold should be strong enough because the mold should function as an insulator in addition to function as a protective material.

The heater structure in the present invention heats the air pump effectively because the heating efficiency of the heater can be improved.

One aspect of the present invention provides a heater structure having an air pump that introduces and pumps external air, and a heater that is mounted on the air pump and heats the air pump, wherein the heater is comprised of a heat generator and a mold made of resin or rubber that covers the heat generator, the heat generator is comprised of a positive temperature coefficient thermistor heating element having a pair of electrode layers, a first electrode terminal, a second electrode terminal, and an insulation case that is a box shape with one side opened, the first electrode terminal and the positive temperature coefficient thermistor heating element are electrically connected and installed in the insulation case, the second electrode terminal is made of an elastic metal plate having a substantially U-shaped cross section, by using a U-shaped opening of the second electrode terminal to hold the positive temperature coefficient thermistor heating element, the first electrode terminal and the insulation case, the second electrode terminal and the positive temperature coefficient thermistor heating element are electrically connected, and the second electrode terminal and the first electrode terminal are insulated by the insulation case, an opening surface of the insulation case faces with the air pump, a protective sheet is placed on a surface of the mold with which the air pump is in contact, and a sum of a thickness of the mold with which the air pump is in contact and a thickness of the protective sheet is thinner than a thickness on an opposite side of the mold of the heater.

In another aspect, the thickness of the mold with which the air pump is in contact is thinner than the thickness of the protective sheet.

In another aspect, the mold is made of silicone rubber, and the protective sheet is made of glass fiber cloth in which silicone rubber is impregnated.

In another aspect, the sum of the thickness of the mold with which the air pump is in contact and the thickness of the protective sheet is equal to or less than one-half of the thickness on the opposite side of the mold.

In another aspect, the heater structure is used for a secondary air supplying device of an internal combustion.

Note that the thickness of the mold and the thickness of the protective sheet described above mean the thickness at the position where the heat is actually generated. If the thickness is not uniform, the thickness is measured by an average. Specifically, the thickness is measured by projecting the mold and the protective sheet at the position where the PTC heating element exists.

The heater structure of the present invention can improve heating efficiency because the mold with which the air pump is in contact is thin and the heat is transferred to the air pump effectively. In addition, there is no problem with the strength of the mold because the mold is protected by the protective sheet.

In particular, it is preferable if the mold is made of silicone rubber and the protective sheet is made of glass fiber in which the silicone rubber is impregnated, because the protective sheet is strong enough, the mold and the protective sheet have good heat-resistance, and the mold and the protective sheet can be easily fixed with each other by compressing them.

### BRIEF DESCRIPTION OF THE DRAWINGS

FIG. 1 shows a perspective view of a structure of a heater concerning the present invention.

FIG. 2 shows a cross-sectional view thereof, taken along line II-II′ (y-z surface) in FIG. 1.

FIG. 3 shows a cross-sectional view thereof, taken along line III-III′ (x-y surface) in FIG. 1.

FIG. 4 shows a cross-sectional view thereof, taken along line IV-IV′ (x-z surface) in FIG. 1.

FIG. 5 shows a perspective view of a second electrode terminal.

FIG. 6 shows a perspective view of an insulation case.

FIG. 7 shows a perspective view of an insulation case viewed from a bottom surface.

FIG. 8 shows a schematic perspective view of a heater device mounted on an air pump.

FIG. 9 schematically shows an internal combustion system in which a heater structure of the present invention is used.

### DETAILED DESCRIPTION OF THE INVENTION

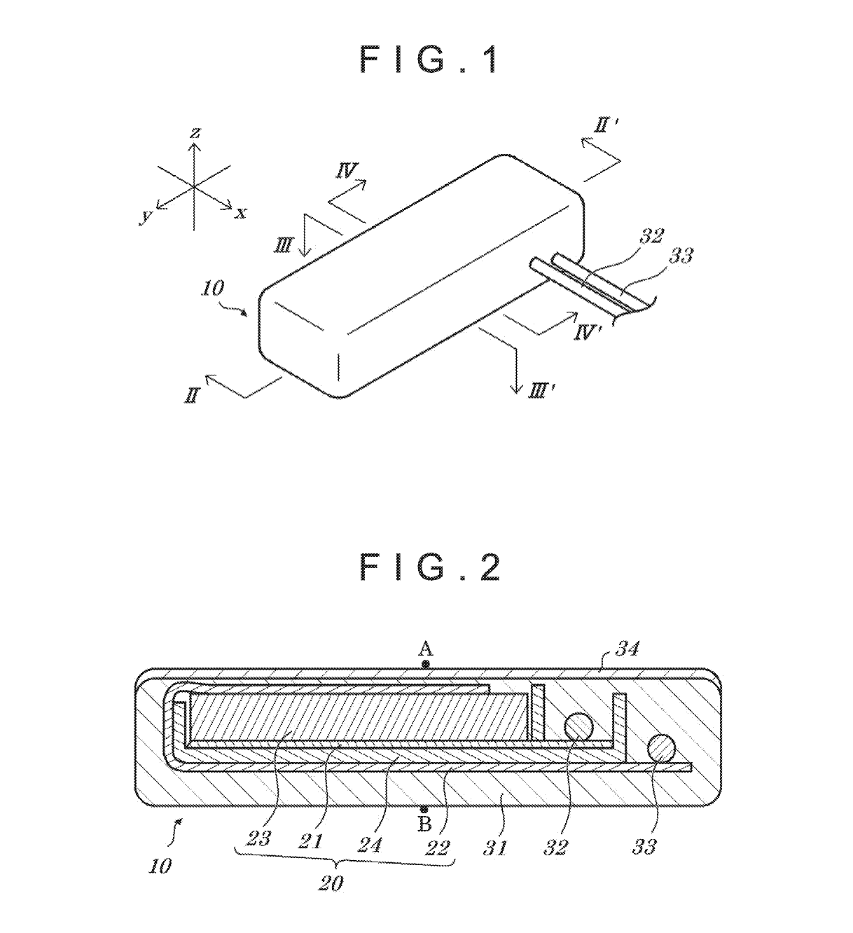

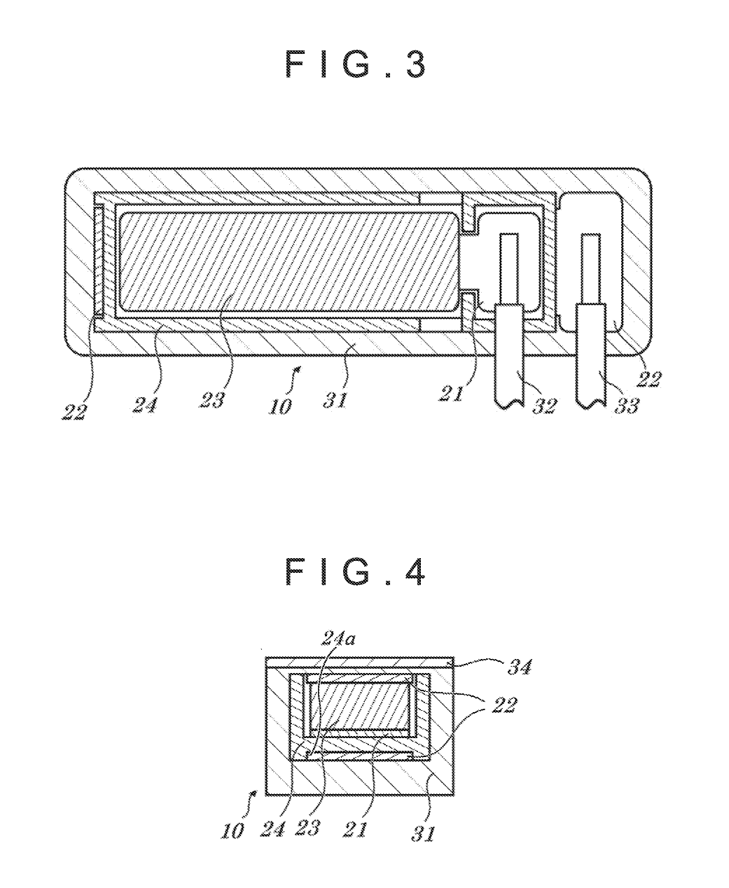

An embodiment of the present invention concerning a heater structure will be described below with reference to FIGS. 1-9. A secondary air supplying device is composed of an air pump 42 that introduces and pumps external air, a secondary air supplying port 41 that supplies the external air pumped from the air pump 42 to an exhaust system of an internal combustion, and a heater 10 that is mounted on the air pump 42 and heats the air pump 42.

The heater 10 is composed of a heat generator 20 and a mold 31 that is made of resin or rubber and covers the heat generator 20. The heat generator 20 is composed of a PTC heating element 23 that has a pair of electrode layers, a first electrode terminal 21, a second electrode terminal 22, and an insulation case 24 that is a box shape with one side opened.

The first electrode terminal 21 is made of highly elastic stainless steel plate of 0.2 mm thickness and is formed into a curved surface shape like an arch from a lateral view. Therefore, if the first electrode terminal 21 is placed on a flat surface and pushed down, the first electrode terminal 21 is biased against the pushing force.

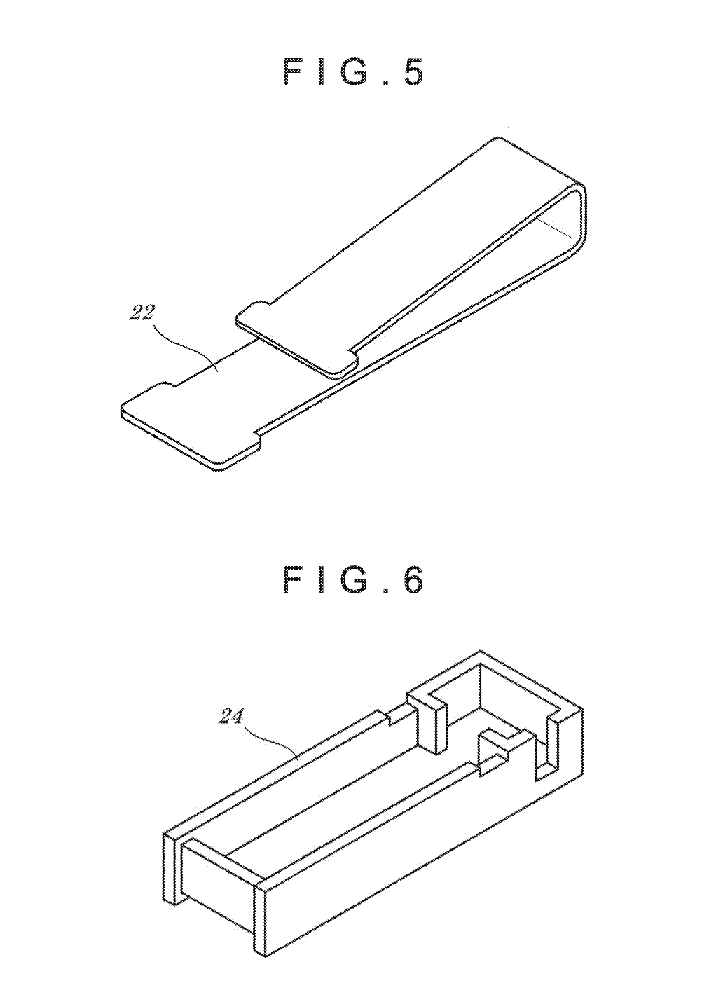

The second electrode terminal 22 has a shape shown in FIG. 5. The second electrode terminal 22 is made of highly elastic stainless steel plate of 0.5 mm thickness and has a U-shaped cross section. As shown in FIG. 5, the second electrode terminal 22 has two approximately parallel plate portions and a vertical plate portion that connects the two parallel plate portions. One of the two parallel plate portions is longer than another, and tips of the two parallel plate portions are wider than other parts. The second electrode terminal 22 is designed to have a height of 4.6 mm at the vertical plate portion and has a space of 1.2 mm at an opening between the tips of the two parallel plate portions. When the second electrode terminal 22 holds the PTC heating element 23, the first electrode terminal 21 and the insulation case 24, the second electrode terminal 22 is biased to close the opening. Note that the vertical plate portion doesn't have to be strictly vertical. For example, the vertical plate portion may be tilted or curved.

Materials of the first electrode terminal 21 and the second electrode terminal 22 can be any elastic materials that function as an electrode. For example, stainless steel plate, phosphor bronze plate, nickel-plated brass plate, tinned brass plate or silver-plated brass plate can be the materials. In particular, stainless steel plate and phosphor bronze plate are preferable because they can keep good elasticity even when they are in a cooling/heating cycle for long periods.

The PTC heating element 23 is composed of barium titanate series ceramic element formed into a square plate of 6.5 mm long, 18.1 mm wide and 2.5 mm thickness. Electrodes made of silver paste are formed on both surfaces of the square plate. One of the surfaces of the electrodes is a positive electrode while another is a negative electrode. Note that the material of the PTC heating element can be selected according to a heating characteristic (e.g. Curie temperature) to be needed.

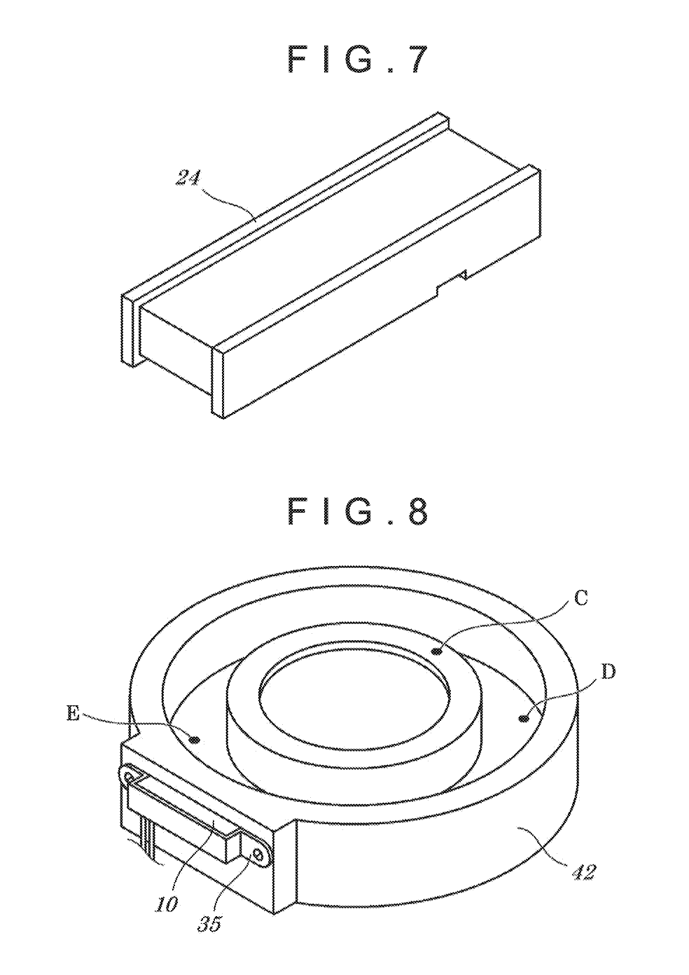

The insulation case 24 is made of polyphenylene sulfide and has a shape shown in FIGS. 6 and 7. The insulation case 24 is a box shape with one side opened and a groove 24 a having the approximately same width as the second electrode terminal 22 is formed on the back of the bottom surface. In addition, a longitudinal side surface shown in FIG. 6 has a height of 3.3 nun from the bottom surface, that is greater than a sum of a thickness of the first electrode terminal 21 and a thickness of the PTC heating element 23.

The following procedures explain how to assemble the components described above to acquire the heat generator 20. At first, the first electrode terminal 21 and the PTC heating element 23 are placed in the insulation case 24 in order. Then, the opening of the second electrode terminal 22 is temporarily expanded, and the insulation case 24 in which the first electrode terminal 21 and the PTC heating element 23 are placed is fit into the opening of the second electrode terminal 22. Finally, the second electrode terminal 22 is biased to close the opening in order to hold the first electrode terminal 21 and the PTC heating element 23 in the insulation case 24 toward the second electrode terminal 22, and these components are fixed. Consequently, the second electrode terminal electrically connects to one of terminals of the positive temperature coefficient thermistor heating element, and the first electrode terminal electrically connects to another terminal of the positive temperature coefficient thermistor heating element. In addition, the first electrode terminal 21 and the second electrode terminal 22 are insulated by the insulation case 24.

Here, the groove 24 a having the approximately same width as the second electrode terminal 22 is formed on the back of the bottom surface of the insulation case 24, and the second electrode terminal 22 is fit into the groove 24a. Because the height of the longitudinal side surface of the insulation case 24 is greater than the sum of the thickness of the first electrode terminal 21 and the thickness of the PTC heating element 23 even at the opening of the insulation case 24 as described above, the second electrode terminal 22 is fit into between the longitudinal side surfaces of the insulation case 24. Therefore, the second electrode terminal 22 is fixed and not available to slide laterally by a wall made by the groove 24 a and the longitudinal side surfaces of the insulation case 24. Consequently, circuit malfunction occurs less frequently.

The second electrode terminal 22 is longer than the insulation case 24 at the side placed on the back of the bottom surface of the insulation case 24. In addition, the tip of the second electrode terminal 22 is wider than the insulation case 24 to protrude out of the insulation case 24. Therefore, the tip of the second electrode terminal 22 is in contact with an edge of the wall of the groove 24 a formed on the bottom surface of the insulation case 24 and functions as a stopper to prevent the second electrode terminal 22 from being disconnected in a direction opposite to the fitting direction.

In the heat generator 20 of the present embodiment, only the second electrode terminal 22 is placed on one side while another side is laminated and insulated by the first electrode terminal 21, the insulation case 24 and the second terminal 22. Therefore, the temperature is different on each side of the heat generator 20 when generating heat. Accordingly, the side where only the second electrode terminal 22 is placed (upper side in FIGS. 2 and 4) is located to contact the air pump 42 normally. Here, the temperature difference between both sides can be specified by changing a thickness of the bottom surface of the insulation case 24, by making a hole on the bottom surface of the insulation case 24, or by changing the material of the insulation case 24 to the material having different thermal conductivity.

A connecting method to connect a lead wire 32 with the first electrode terminal 21 or to connect a lead wire 33 with the second electrode terminal 22 can be selected arbitrarily. For example, a soldering, a welding or a terminal insertion can be selected. The lead wire 32 and the lead wire 33 should be connected at first, and then other components should be assembled from the view point of workability.

After the first electrode terminal 21, the PTC heating element 23, the insulation case 24 and the second electrode terminal 22 are assembled to acquire the heat generator 20 as described above, the mold 31 made of resin or rubber is formed around the assembled components. By forming the mold 31, the heater 10 is waterproofed and the second electrode terminal 22 is more tightly fixed not to slide. Therefore, the circuit malfunction can be surely eliminated. In addition, the mold 31 can absorb external shock elastically. Although the resin or rubber used for the mold 31 can be any general materials, silicone rubber having good flexibility and heat-resistance is used for the present embodiment. Note that derived parts of the lead wires 32 and 33 can be sealed by RTV silicone rubber for waterproofing.

A protective sheet 34 is formed on a surface of the mold 31 with which the heating object is in contact. The protective sheet 34 should have good tensile strength and should not restrict the flexibility of the mold 31 because the protective sheet 34 is used to reinforce the mold 31. For example, fiber cloth in which various resins and rubbers are impregnated is preferable. Glass fiber cloth of 0.3 mm thickness in which silicone rubber is impregnated is used for a material of the protective sheet 34 in the present embodiment because the material has good adhesiveness with the silicone rubber used for the mold 31. In the heater 10, a sum of the thickness of the mold 31 with which the heating object is in contact and the thickness of the protective sheet 34 is thinner than a thickness of an opposite side of the mold 31. In FIGS. 2 and 4, the upper side is in contact with the heating object. In the present embodiment, the sum of the thickness of the mold 31 with which the heating object is in contact and the thickness of the protective sheet 34 is 0.5 mm, while the thickness of the opposite side of the mold 31 is 2.5 mm. Therefore, heat from the heat generator 20 is effectively transmitted to the heating object and the heating efficiency of the heater 10 is improved.

As described above, the sum of the thickness of the mold 31 with which the heating object is in contact and the thickness of the protective sheet 34 is about one-fifth of the thickness of the opposite side of the mold 31 in the present embodiment. Of course, the above ratio of the thickness is just one of the examples. Even if the ratio of the thickness is smaller than the ratio of 1:5, the heating efficiency is improved. For example, when the ratio of the thickness is 1:2, the efficiency is improved.

The protective sheet 34 is a fiber cloth in which the same material as the mold 31 is impregnated. In other words, the side with which the heating object is in contact is formed by laminating the mold 31 and the fiber cloth in which the same material as the mold 31 is impregnated. The fiber cloth is located on the side of the heating element. In other words, the heat generator 20 is covered by the mold 31, and the fiber cloth in which the same material as the mold 31 is impregnated is laminated on the side with which the heating object is in contact. Therefore, the heating object can be protected regardless of the thickness of the heating object, and the mold 31 is prevented from peeling off for long periods.

The mold 31 and the protective sheet 34 can be formed by the conventional methods such as a compression molding and an injection molding using a metal mold. For example, the mold 31 and the protective sheet 34 can be formed by placing them around the heat generator 20 and then pressurizing. If the protective sheet 34 is placed without placing the mold 31 on the surface of the heat generator 20 with which the air pump 42 is in contact, the heating efficiency can be extremely improved. However, the mold 31 should be placed between the heat generator 20 and the protective sheet 34 to keep enough strength, no matter how thin the mold 31 might be.

The heater 10 acquired as described above can be mounted on the air pump 42 as shown in FIG. 8, for example. Especially, when the heater 10 is used for the internal combustion of the vehicle, electrical conduction of the heater 10 is controlled in conjunction with an ambient temperature, a vehicle speed and other elements. As a result, the heat from the heater 10 is transferred to the air pump 42 to prevent the air pump 42 from freezing.

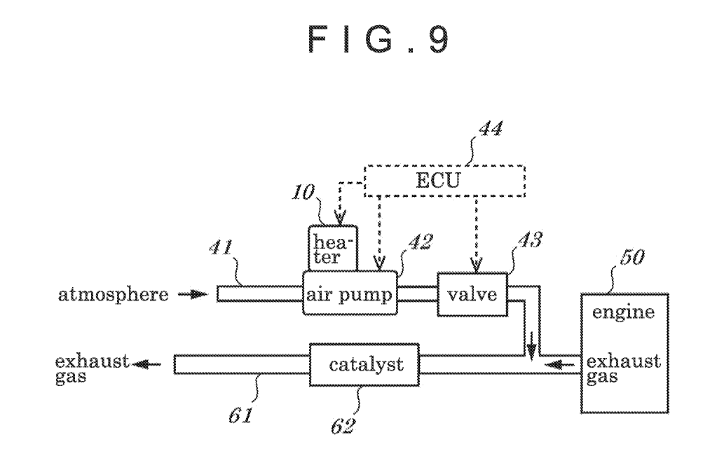

FIG. 9 schematically shows an internal combustion system in which a heater structure of the present invention is used. An engine 50 as an internal combustion is connected to an exhaust port 61 to discharge exhaust gas into the atmosphere. In the exhaust port 61, a catalyst 62 is employed to reduce toxic substances in the exhaust gas. In the exhaust port 61, the secondary air supplying port 41 is also connected upstream of the catalyst 62 to supply the atmosphere (secondary air). In the secondary air supplying port 41, the air pump 42 and a valve 43 is placed in order from the upstream side. The air pump 42 and the valve 43 are controlled by an ECU 44. The heater 10 is also controlled by the ECU 44. The ECU 44 is an electronic control unit to control the whole engine system. The air pump 42 has the same structure as the conventional air pump to compress the secondary air and pump it to the exhaust port 61. The valve 43 is controlled by the ECU 44 to be opened when supplying the secondary air. The secondary air supplying port 41, the air pump 42, the valve 43 and the ECU 44 function as a secondary air supply system to supply the secondary air to the exhaust system of the engine. In addition, the exhaust port 61 and the catalyst 62 function as the exhaust system of the engine 50.

The following measurement is performed about temperatures of the heater 10 acquired as described above. As shown in FIG. 2, a center of the side with which the air pump 42 is in contact (the side where only the second electrode terminal 22 is placed) is defined as a point A, and a center of the opposite side (the side where the first electrode terminal 21, the insulation case 24 and the second electrode terminal 22 are laminated) is defined as a point B, and difference in temperature between the point A and the point B is measured. In the measurement, the PTC heating element 23 having the Curie temperature of 180° C. is used, ambient temperature is set to 20° C., and temperatures of the point A and B are measured 600 seconds after heating is started. An average is calculated from 4 samples and shown in Table 1. As a comparison example, the protective sheet is omitted from the above embodiment, the thickness of the mold 31 with which the air pump 42 is in contact is specified to 1.5 mm, the thickness of the opposite side is specified to 1.5 mm, and difference in temperature between the point A and the point B is measured.

TABLE 1

| | present embodiment | comparison example |
|---|---|---|
| temperature of the point A | 176.4° C. | 174.2° C. |
| temperature of the point B | 137.8° C. | 152.7° C. |
| difference in temperature | 38.6° C. | 21.5° C. |

As shown in Table 1, the heater concerning the present embodiment has a difference in temperature between one side and another side. Especially, on the heater of the present embodiment, the difference in temperature between the point A and the point B is greater than that of the comparison example. Therefore, the PTC heating element 23 of the present embodiment can transfer heat effectively to the heating object.

Furthermore, temperatures of the air pump 42 are measured with the heater 10 is actually mounted on the air pump 42 about both for the present embodiment and the comparison example. The air pump 42 has a shape schematically shown in FIG. 8 and is made of stainless steel. The heater 10 is mounted on the air pump 42 by a mounting bracket 35 that is made of stainless steel. In the measurement, the PTC heating element 23 having the Curie temperature of 217° C. is used, ambient temperature is set to −10° C., wind speed is set to 8.0 m/s and temperatures of the points C, D and E also shown in FIG. 8 are measured 1000 seconds after heating is started. A result of the measurement is shown in Table 2.

TABLE 2

| | present embodiment | comparison example |
|---|---|---|
| temperature of the point C | 4.8° C. | −0.3° C. |
| temperature of the point D | 5.2° C. | −0.1° C. |
| temperature of the point E | 13.8° C. | 5.6° C. |

As shown in Table 2, temperature of the air pump 42 heated by the heater 10 of the present embodiment is higher than that of the comparison example at any of the measured points. Therefore, the heating efficiency of the heater 10 of the present embodiment is confirmed to be high.

The heater 10 of the present embodiment has enough strength even at the thinner part of the mold 31 by being protected by the protective sheet 34. Therefore, no cracks or damage is on the mold 31 even when it is mounted on the air pump 42 by the mounting bracket 35.

As described above, the present invention can improve the heating efficiency of the heater and can provide the heater structure to surely prevent the air pump from freezing. The heater structure of the present invention can be used for the secondary air supplying device suitably. In addition, the secondary air supplying device having the heater structure of the present invention can be used for the internal combustion of the vehicle suitably.

Note that, this invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

While the invention has been particularly shown and described with respect to preferred embodiments thereof, it should be understood by those skilled in the art that the foregoing and other changes in form and detail may be made therein without departing from the sprit and scope of the invention as defined in the appended claims.

What is claimed is:

1. A heater structure having an air pump that introduces and pumps external air, and a heater that is mounted on the air pump and heats the air pump, wherein
the heater is comprised of a heat generator and a mold made of resin or rubber that covers the heat generator;
the heat generator is comprised of a positive temperature coefficient thermistor heating element having a pair of electrode layers, a first electrode terminal, a second electrode terminal, and an insulation case that is a box shape with one side opened;
the first electrode terminal and the positive temperature coefficient thermistor heating element are electrically connected and installed in the insulation case;
the second electrode terminal is made of an elastic metal plate having a substantially U-shaped cross section;
a U-shaped opening of the second electrode terminal holds the positive temperature coefficient thermistor heating element, the first electrode terminal and the insulation case;
the second electrode terminal electrically connects to one of terminals of the positive temperature coefficient thermistor heating element;
the first electrode terminal electrically connects to another terminal of the positive temperature coefficient thermistor heating element;
the second electrode terminal and the first electrode terminal are insulated by the insulation case;
an opening surface of the insulation case faces with the air pump;
a protective sheet is placed on a surface of the mold with which the air pump is in contact; and
a sum of a thickness of the mold with which the air pump is in contact and a thickness of the protective sheet is thinner than a thickness on an opposite side of the mold of the heater.

2. The heater structure according to claim 1, wherein:
the thickness of the mold with which the air pump is in contact is thinner than the thickness of the protective sheet.

3. The heater structure according to claim 1, wherein:
the mold is made of the silicone rubber; and
the protective sheet is made of glass fiber cloth in which silicone rubber is impregnated.

4. The heater structure according to claim 1, wherein:
the sum of the thickness of the mold with which the air pump is in contact and the thickness of the protective sheet is equal to or less than one-half of the thickness on the opposite side of the mold.

5. The heater structure according to claim 1, wherein:
the heater structure is used for a secondary air supplying device of an internal combustion.
